(19) United States
(12) Patent Application Publication
(10) Pub. No.: US 2018/0133587 A1
(43) Pub. Date: May 17, 2018

(54) MATH SKILL GAME

(71) Applicant: CYPHERING INC., Toronto (CA)

(72) Inventors: Dannial BAKER, SR., Toronto (CA); Dannial BAKER, JR., Toronto (CA)

(21) Appl. No.: 15/570,240

(22) PCT Filed: Apr. 27, 2015
(86) PCT No.: PCT/CA2015/050349

§ 371 Date: Oct. 27, 2017

(51) Int. Cl. A63F 1/04; G09B 19/02

(52) U.S. Cl. CPC A63F 1/04; A63F 2003/046; A63F 2001/0416; G09B 19/02

(57) ABSTRACT

Described herein is a math card capture game comprising providing a plurality of players, and a deck of cards comprising at least two series of cards numbered consecutively from 1 to 10, each card bound by a face side and a back side, the face side displaying a numerical value; dealing a plurality of table cards face side up and dealing a plurality and equal number of hand cards face side down to each player; capturing cards during each player's turn by formulating an equation using at least one table card, at least one hand card and one or more available mathematical operators; discarding a hand card to be placed face side up as a table card if the player is unable to formulate an equation during the player's turn; counting captured cards for each player to determine a winner. The math card capture game may optionally include a random generator device—such as a coin, spin wheel or die—displaying a mathematical operator. Also described is a math number capture game comprising providing a predetermined set of integer numbers; providing a predetermined integer result; and selecting two or more integer numbers and generating a mathematical equation using the selected two or more of the integer numbers and at least one mathematical operator to yield the predetermined result.

### BACKGROUND OF THE INVENTION

### Field of the Invention

The present invention relates to mathematic education, and more particularly to a math skill game.

### Description of the Related Art

Declining math skills of high school and/or primary school students is a well-recognized problem.

In 2007, The United States National Academies, a reputed advisory organization, issued a frequently cited report called “Rising Above the Gathering Storm,” warning that America was losing critical ground in math and science skills.

The report traced America's decline to “a recurring pattern of abundant short-term thinking and insufficient long-term investment.” The mosaic of culprits included: decades of declining or flat spending on research in most physical sciences, mathematics and engineering; dwindling education funding; and aggressive pushes by other countries to improve their math and science education.

Another well cited report relating to math skills is the Programme for International Assessment (PISA) periodically prepared and released by the Organisation for Economic Cooperation and Development (OECD). Since 2000, the OECD has attempted to evaluate the knowledge and skills of 15-year olds across the world through its PISA test. More than 510,000 students in 65 educational systems took part in the 2012 PISA test (rankings released 3 Dec. 2013), which covered mathematics, reading and science, with a primary focus on mathematics—which the OECD states is a “strong predictor of participation in post-secondary education and future success.”

Among the 65 educational systems taking part in the 2012 PISA report approximately 40 countries posted below average results reflecting skewing of the average score by a few top performers. Of added concern is that many economies that provide significant public funding of educational programs ranked poorly with reference to 2012 PISA average math score of 494 including in descending order with each country's 2012 PISA math score indicated in brackets: UK (494), Iceland (493), Latvia (491), Luxembourg (490), Norway (489), Portugal (487), Italy (485), Spain (484), Russian Federation (482), Slovak Republic (482), USA (481), Lithuania (479), Sweden (478), Hungary (477), Croatia (471), Israel (466), Greece (453), Serbia (449), Turkey (448), Romania (445), Cyprus (440), Bulgaria (439), UAE (434), Kazakhstan (432), Thailand (427), Chile (423), Malaysia (421), Mexico (413), Montenegro (410), Uruguay (409), Costa Rica (407), Albania (394), Brazil (391), Argentina (388), Tunisia (388), Jordan (386), Colombia (376), Qatar (376), Indonesia (375), and Peru (368). Other reports have raised concerns regarding declining math proficiency of high school and/or primary school students in other countries such as Canada, Finland, Sweden, Germany, France, Australia, Ireland, and Poland. In most reports, a few Asian nations appear to be consistent top performers with the rest of the world lagging behind. For example, Shanghai (math score—613), Singapore (573), Hong Kong (561), Taiwan (560), South Korea (554), Macau (538) and Japan (536) dominated rankings as the leading countries and/or economies in the 2012 PISA report. Students in Shanghai performed so well in math testing that the OECD report compares their scoring to the equivalent of nearly three years of schooling above most OECD countries.

Despite well-developed educational infrastructure and significant public funding for pre-university education many countries have performed poorly in math testing in the 2012 PISA report and other reports indicating that a solution to declining math skills may need more than just investing greater levels of funding into existing educational programs. New educational solutions may be needed.

A growing number of researchers are recognizing the need for tools and educational strategies to engage students and prevent disengagement of students. For example, a group led by Janette Bobis (Switching on and switching off in mathematics: An ecological study of future intent and disengagement amongst middle school students (2012) A Martin, J Anderson, J Bobis, J Way, R Vellar. Journal of Educational Psychology 104 (1), 1-18) concluded that among factors affecting engagement/disengagement a student's personal attributes, such as their confidence to do mathematics, the value they placed on the subject, their enjoyment level and their anxiety level play a significant role.

A number of functional solutions addressing engagement by increasing enjoyment levels and/or confidence levels have been disclosed, for example in U.S. Pat. No. 8,771,050 (issued 8 Jul. 2014), U.S. Pat. No. 8,596,641 (issued 3 Dec. 2013), U.S. Pat. No. 8,579,288 (issued 12 Nov. 2013), U.S. Pat. No. 8,523,573 (issued 3 Sep. 2013), U.S. Pat. No. 7,604,237 (issued 20 Oct. 2009), U.S. Pat. No. 7,182,342 (issued 27 Feb. 2007), U.S. Pat. No. 6,609,712 (issued 26 Aug. 2003), U.S. Pat. No. 6,116,603 (issued 12 Sep. 2000), U.S. Pat. No. 6,062,864 (issued 16 May 2000), U.S. Pat. No. 5,772,209 (issued 30 Jun. 1998), U.S. Pat. No. 5,366,226 (issued 22 Nov. 1994), U.S. Pat. No. 5,149,102 (issued 22 Sep. 1992), U.S. Pat. No. 4,561,658 (issued 31 Dec. 1985), U.S. Pat. No. 4,258,922 (issued 31 Mar. 1981), and US Patent Application Publication Nos. 20120322559 (published 20 Dec. 2012) and 20110275038 (published 10 Nov. 2011). However, none of these solutions have achieved widespread acceptance in any educational or recreational context.

Accordingly, there is a continuing need for an alternative math game.

### SUMMARY OF THE INVENTION

In an aspect there is provided a math card capture game comprising:

a deck of cards comprising at least two series of cards numbered consecutively from 1 to 10, each card bound by a face side and a back side, the face side displaying a numerical value; and

a random generator device displaying a mathematical operator.

In another aspect there is provided a method of playing a math card capture game comprising:

providing a plurality of players, a deck of cards comprising at least two series of cards numbered consecutively from 1 to 10, each card bound by a face side and a back side, the face side displaying a numerical value and a random generator device displaying a mathematical operator;

dealing a plurality of table cards face side up and dealing a plurality and equal number of hand cards face side down to each player;

operating the random generator device at one or more intervals to determine one or more available mathematical operators;

capturing cards during each player's turn by formulating an equation using at least one table card, at least one hand card and one or more available mathematical operators;

discarding a hand card to be placed face side up as a table card if the player is unable to formulate an equation during the player's turn;

counting captured cards for each player to determine a winner.

In yet another aspect there is provided a method of playing a math card capture game comprising:

providing a plurality of players, and a deck of cards comprising at least two series of cards numbered consecutively from 1 to 10, each card bound by a face side and a back side, the face side displaying a numerical value;

dealing a plurality of table cards face side up and dealing a plurality and equal number of hand cards face side down to each player;

capturing cards during each player's turn by formulating an equation using at least one table card, at least one hand card and one or more available mathematical operators;

discarding a hand card to be placed face side up as a table card if the player is unable to formulate an equation during the player's turn;

counting captured cards for each player to determine a winner.

In a further aspect there is provided a math skill game comprising:

a predetermined set of integer numbers, a predetermined integer result and instructions for selecting two or more of the integer numbers and generating a mathematical equation using the selected two or more integer numbers and at least one predetermined mathematical operator to yield the predetermined result.

In still a further aspect there is provided a method of playing a math skill game comprising:

providing a predetermined set of integer numbers;

providing a predetermined integer result; and

selecting two or more integer numbers and generating a mathematical equation using the selected two or more of the integer numbers and at least one mathematical operator to yield the predetermined result.

### BRIEF DESCRIPTION OF THE DRAWINGS

FIG. 1 shows an example of steps performed during a math number capture game;

FIG. 2 shows an example of steps performed during a math card capture game; and

FIG. 3 shows an example of a playing set-up for a math card capture game.

### DETAILED DESCRIPTION OF PREFERRED EMBODIMENTS

A math skill game and variants or modifications thereof described herein allows player(s) to enjoy math training and engage in math as a recreational or entertainment activity.

The math skill game provides player(s) with a different method to completing an equation than is provided in traditional mathematics curricula of most primary schools. A typical approach to testing math skills in primary schools is to provide a student with numbers linked by arithmetic operator(s) and require a student to complete an equation by determining a result. For example, a student provided with an incomplete statement or equation such as “5+7−3=” answers with a result of “9”. Using the same example, in the math skill game a player is provided with the result “9” and the requirement to use each of the numbers in the group “5, 7, 3”, with the player providing the mathematical operators and the order of operations needed to use the group of numbers to achieve the result. In another example, a player may be provided with the result “9” and a choice of one or more numbers within the group “5, 7, 3, 8”, with the player providing a first solution of “5+7−3” or a second solution of “8−7+5+3”. The second solution may be rewarded with a higher score as it captures a greater number of terms from the group.

The math skill game can use one or more of the four standard arithmetic operators of addition, subtraction, division and multiplication. Moreover, the math skill game can be readily modified and is scalable to use any mathematical operator or function depending on the skill level of the player(s), including for example root, exponential, inverse, logarithmic or trigonometric functions. In still another example, addition, subtraction, multiplication, division, root, exponent, logarithm, floating point (eg. floating decimal point), moving point (eg., moving decimal point, percentage), fraction, computer code, algorithm, and inverse operators may be used individually or in any combination as desired at a player's turn in the math skill game. Additionally, any positional numeral system may be used either alone or in combination, including for example binary (base 2), octal (base 8), decimal (base 10), duodecimal (base 12) or hexadecimal (base 16).

Students tested in traditional math curricula, particularly at the primary school level can succeed based on memorization such as memorization of multiplication or division tables or memorization of sums or differences of two numbers. This memorization can lead a student to recognize each equation in isolation as a fixed statement without either fully understanding the concept of an equation or understanding the inherent variability in formulating an equation, for example a student may recognize that 2+2=4 and 2*2=4 and 2²=4 and 8/2=4 and 5−1=4 and 3+1=4 without appreciating that 2+2=2*2=2²=8/2=5−1=3+1, etc. In other words, if 8 year old students were queried as to what 2+2 is equal to most would answer quickly and correctly with an answer of “4”. However, a follow-up query asking what else 2+2 is equal to would likely confuse a majority of these same students. The math skill game can lead a player to a better understanding of the concept of an equation and its inherent variability by prompting a player to consider multiple solutions by selecting one or more math operators or functions given a group of numbers and a single result.

In a first variant of the math skill game, a predetermined result is provided along with a predetermined group of numbers. A player selects two or more of the numbers and the player provides mathematical operators to link two or more selected numbers and order of operations to formulate an equation to achieve the predetermined result. The first variant of the math skill game may be interchangeably referred to as a math number capture game.

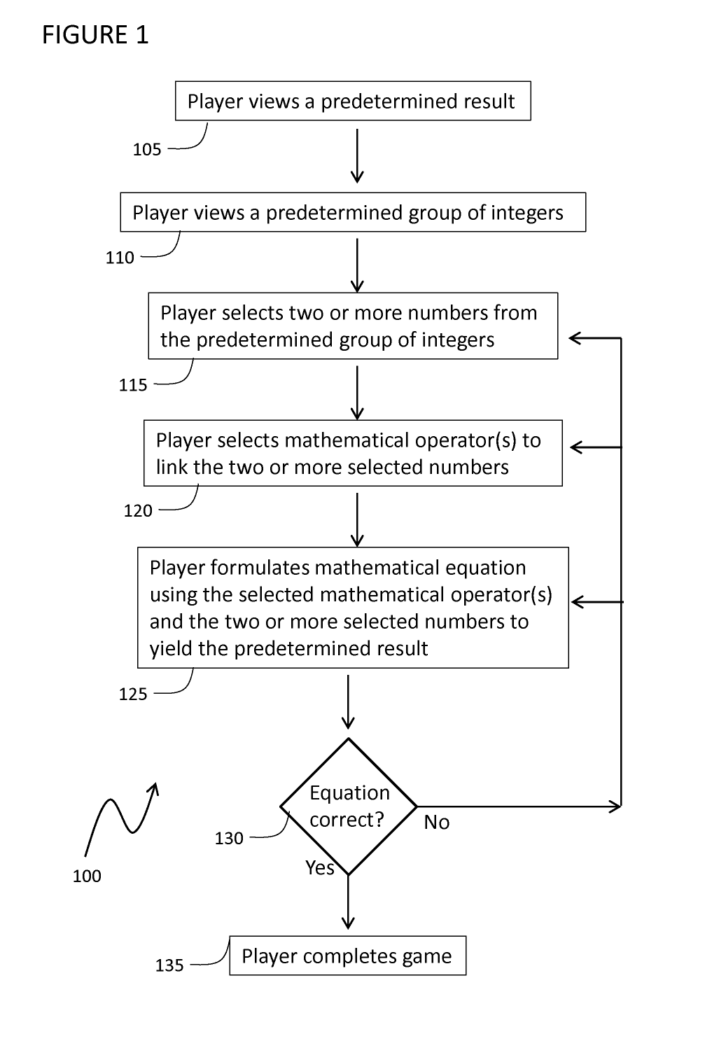

FIG. 1 shows an example of steps performed by a player during a math number capture game 100. To begin math number capture game 100 the player views a predetermined result 105 and a predetermined group of integers 110. The player selects 115 at least two numbers from the predetermined group of integers. The player then selects mathematical operators 120 and attempts to formulate an equation using the selected numbers 125 to yield the predetermined result. If the equation is correct 130 then the player successfully completes the game 135. If the equation is incorrect 135 then player returns to a previous step, typically step 115, 120 and/or 125, to make further attempts to formulate equations until arriving at a correct equation.

The predetermined result may be constant, for example the math skill game may be presented in a series of queries or puzzles in which the predetermined result is always “22”. Alternatively, the predetermined result may vary in each implementation, so that in a series the predetermined result may change from one query or puzzle to the next. Similarly, the choice of mathematical operators or functions may vary depending on the skill level of the target audience. For example, for 5 to 7 year old players the choice of mathematical operator could be limited to addition and subtraction, with multiplication and division further included for 8 to 10 year olds, exponent, moving decimal point, fractions and root functions further included for 11 to 13 year olds, logarithmic, inverse, floating point, and trigonometric functions included for 14 to 16 year olds, and algorithms, computer code and calculus for even more advanced students and players. Additionally, any positional numeral system may be used either alone or in combination, including for example binary (base 2), octal (base 8), decimal (base 10), duodecimal (base 12) or hexadecimal (base 16). The size of the predetermined group of numbers and the rules and/or rewards for capturing more or less of the predetermined numbers may be varied as desired depending on specific applications. Thus, the components of the math skill game may be modified to suit an age group or skill level. As an example, the expected math curricula for a particular age group may provide a useful guide for determining a desired complexity for the math skill game for that age group.

Each math number capture game may have a singular or a plurality of possible correct equations. In one example, where multiple solutions are possible, players may be awarded points for each correct equation. In another example with multiple possible solutions, players may be required to determine all possible correct equations to complete the game.

This first variant of the math skill game may be designed to test various degrees of skill level and may be presented as a puzzle in formats similar to crossword or Sudoku puzzles, for example in a daily newspaper, a journal, a magazine, a book, a networked website, a software application and the like. Furthermore, this first variant of the math skill game may be incorporated into math curricula, for example as a skill testing question in a math book or in a math test or as a math training aid such as math flash cards.

In a second variant of the math skill game, a deck of cards comprising a plurality of suits, each suit comprising ten cards numbered consecutively from 1 to 10 is used to play a math card capture game. The second variant of the math skill game may be interchangeably referred to as a math card capture game. Players are dealt cards to hold in hand, and during each turn a player must select a card held in hand to capture one or more cards from a group of table cards lying face up and visible to all players by formulating an equation using the numerical value of each of the one or more table cards linked by a mathematical operator to equal the card selected from the player's hand. If the player is unable to formulate an equation then the player discards one card from the player's hand and places the discarded card face up with the group of table cards. The components of the second variant of the math skill game, may be modified to achieve any desired complexity as long as a modification retains the feature of a player capturing table cards by using mathematical operators or functions to formulate an equation. For example, the number of suits, the number of cards in each suit, the number of cards dealt to a player's hand, the number of cards dealt as table cards, the choice of mathematical operators or functions may all be modified to accommodate a desired implementation. Optionally, a random generator device for displaying a mathematical operator or function may be used to determine one or more mathematical operators or functions at the beginning of a game or at any predetermined stage within a game, for example at each deal or at each player's turn. The random generator device may be, for example, a die or dice with faces displaying a mathematical operator, a spin wheel with sectors displaying a mathematical operator, or an electronic random generator with a display for showing an image of a mathematical operator.

For illustrative purposes, a few examples of the math card capture game will now be described.

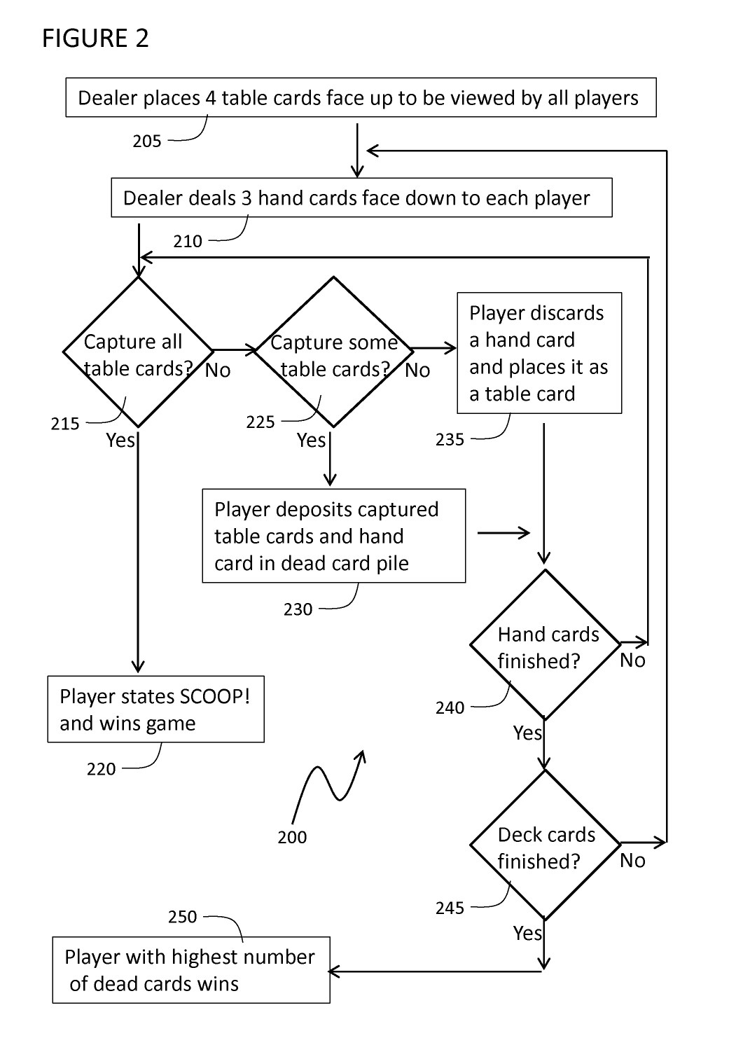

Games can typically be played with two, three, four or six players. FIG. 2 shows an example of steps performed in a math card capture game 200. The deck is shuffled and the dealer deals out 3 cards to each player 210 and places four cards face up on the table 205.

Each player takes a turn, either picking up card(s) on the table with a card from the player's hand 225 or laying down a card from the player's hand 235. Cards that are picked up from the table together with the card from the player's hand are dead cards and are placed in a pile 230 beside the player who picked them up to be counted at the end of the game. After each player has played all their hand cards 240 (in this example three turns to play three hand cards, one hand card per turn), the dealer deals another three cards to each player, no cards to the table and play continues. This continues until either all of the cards are eventually dealt out and played 245 or until a SCOOP! occurs 215. A SCOOP! occurs when a player, on the player's turn, picks up all of the cards 215 on the table—optionally the player can yell out “SCOOP!”—and consequently wins the game 220. Otherwise, the winner, if the game continues until all of the cards are dealt and played 245 and there is no SCOOP!, is the player who has the most dead cards at the end of the game 250.

A SCOOP! feature allows a player to win a game in a single turn. This aspect of the game is important as it means that it is possible for a player to win the game, even on the last play of the game. It is hoped that this aspect will stop players from feeling discouraged during the game and will encourage players to continue to play notwithstanding another player having accumulated significantly more dead cards—at any time during the game.

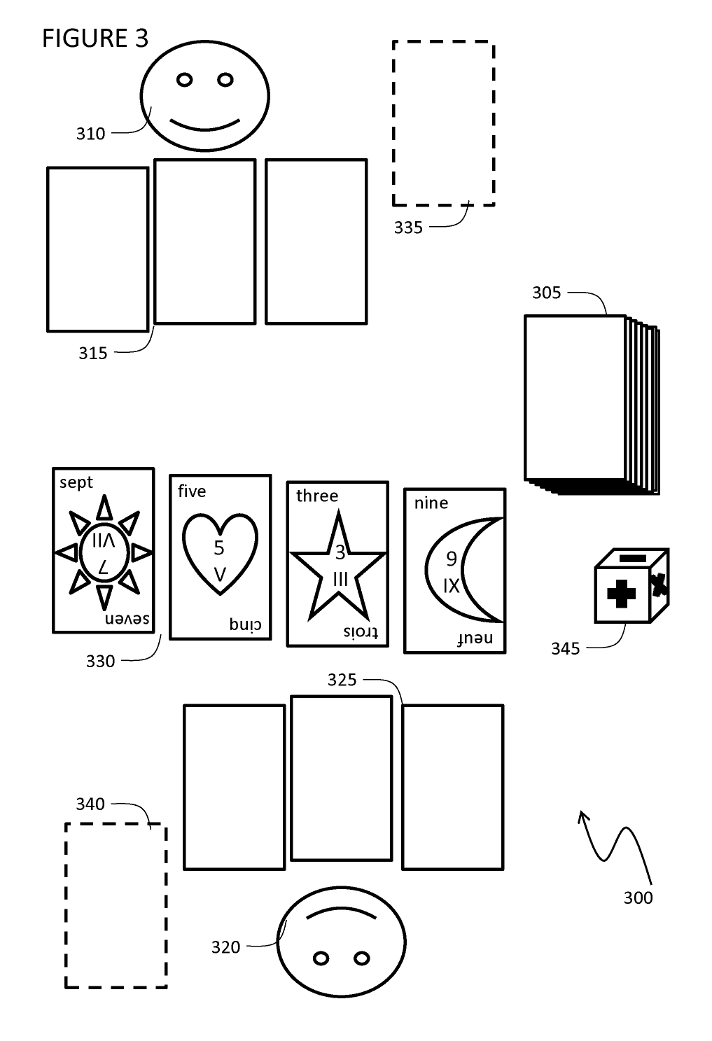

FIG. 3 shows an illustrative initial setup for a math card capture game 300. From a shuffled card deck 305 Player A 310 is dealt three hand cards 315 and Player B 320 is also dealt three hand cards 325. Both Player A hand cards 315 and Player B hand cards 325 are dealt face down. In between Player A 310 and Player B 320 four table cards 330 are placed face up so as to be viewed by both Players A and B. Player A 310 maintains a dead card pile 335 to collect table cards and hand cards captured by Player A. Similarly, Player B 320 maintains a dead card pile 340 to collect table cards and hand cards captured by Player B. Optionally, a die displaying mathematical operators may be used at one or more intervals during the math card capture game 300. Other examples of optional elements include a timer, a writing utensil and a writing sheet (not shown).

In one example, the math card capture game may be played using an addition operator as the sole mathematical operator and may be referred to as the “addition game”. The deck is shuffled. The dealer then deals each player three cards, face down. The dealer then places four cards from the deck into the middle of the table, face up (cards which are face up on the table throughout the game are called table cards). The player to the left of the dealer starts the game. On the player's turn, the player attempts to capture cards on the table by addition of numerical values of table cards to equal a card in the player's hand or have the same numbered card (addition of the card value to the value of zero) in the player's hand as on the table. The table cards are then picked up from the table and together with the card in the player's hand, are placed beside the player and are not used again in the game. These cards can be called dead cards and at the end of the game, if the game is not won by a SCOOP! the player with the highest number of dead cards wins the game. If however, on the player's turn, the player does not have a card in the player's hand which can be used to pick up card(s) from the table, the player must place one of the player's cards on the table, face up, which card then becomes one of the table cards. After the player has played by either picking up card(s) from the table or laying a card face up on the table, it is the next player to the left's turn to do the same. The play continues around three times until each player has played one way or the other, all three of the originally dealt three cards. The dealer then deals another 3 cards to each player. The dealer does not place any further cards face up on the table after the first round of cards. The play continues as before until all of these three cards of each player are played and another three cards are dealt to each player. This continues until all of the cards are eventually dealt and played, at which time each player counts the number of dead cards the player has collected and the player with the most dead cards wins.

A play-by-play working example of the math card capture game using an addition operator is now described. The play-by-play working example is described for 2 players, Player A and Player B.

Dealt: a 7, a 3 and a 2 cards to Player A and a 9, a 6 and a 1 cards to Player B (the dealer) with a 7, a 5, a 3 and a 2 cards face up on the table.

Player A has a 7, a 3 and a 2 cards in Player A's hand and there are a 7, a 3, a 2 and a 5 cards face up on the table. Player A could pick up the 7 card from the table and place the 7 card in Player A's hand and the 7 card from the table beside Player A as dead cards (7+0=7). However, Player A could also do the same with Player A's 3 card, picking up the table 3 card (3+0=3) or in the further alternative, do the same with Player A's 2 card with the 2 card on the table (2+0=2). However, Player A could also chose to pick up the 5 and 2 card from the table with Player A's 7 card. (5+2=7) This would give Player A three cards in Player A's dead card pile rather than only two cards from the alternative plays. There are certain strategies as to which play the player will make at this time, depending on the number of players, how advanced in the game the play is and the number of dead cards the player has. In this example Player A picks up the 2 and the 5 cards and lays down with the 7 card from Player A's hand which cards are placed in Player A's dead card pile, leaving the 7 and the 3 cards face up on the table and a 3 and a 2 card in Player A's hand.

Player B has a 8, a 6 and a 1 cards in Player B's hand and there remains, the 7 and 3 cards face up on the table. None of the cards on the table equals to or can be added up to equal to a card in Player B's hand, therefore Player B cannot pick up any of the cards on the table and must lay one of Player B's hand cards face up on the table which then becomes a table card. There are certain strategies as to which card the player would lay down at this time, depending on the number of players, how advanced in the game the play is and the number of dead cards the player has. In this example Player B lays down the 1 card, leaving a 7, a 3 and a 1 cards as table cards and a 8 and a 6 cards in Player B's hand.

It is now Player A's turn again and Player A has a 3 and a 2 as hand cards. There remains a 7, a 3 and a 1 card on the table. Player A can pick up the 3 card from the table with the 3 card in Player A's hand (3+0=3) and therefore lay down in Player A's dead card pile the two 3s which means Player A's dead card pile now has 5 cards in it. There remains a 7 and a 1 on the table and a 2 card in Player A's hand.

Player B has a 8 and a 6 cards in Player B's hand and therefore can pick up the 7 and 1 cards from the table with Player B's 8 card (7+1=8). This means that there are no table cards remaining, and Player B yells out “SCOOP!”. The game is over and Player B has won even though Player A has more dead cards and there are cards yet to be played if the SCOOP! hadn't happened.

In another example, the math card capture game may be played using a subtraction operator as the sole mathematical operator and may be referred to as the “subtraction game”. The set up for the subtraction math card capture game is similar to the set up for the addition math card capture game.

In the subtraction game however, the player, on the player's turn, must:

i) choose a card from the table cards from which to subtract other table cards which will result in a number equal to a card in the player's hand, with these cards being laid down in the player's dead card pile;

ii) choose a card from the table cards which has the same value as a card in the player's hand (ie., subtract with the value zero), with these two cards being laid down in the player's dead card pile; or

iii) place one of the player's hand cards face up on the table, which card then becomes a table card.

A play-by-play working example of the math card capture game using a subtraction operator is now described. The play-by-play working example is described for 3 players, Player A, Player B and Player C.

Dealt: a 7, a 3 and a 2 cards to Player A; a 9, a 6 and a 1 cards to Player B and a 10, a 4 and a 2 cards to Player C (the dealer) with a 7, a 5, a 3 and a 2 face up on the table.

Player A has a 7, a 3 and a 2 cards in Player A's hand and there are a 7, a 3, a 2 and a 5 cards face up on the table. Player A could pick up the 7 card from the table and place the 7 card in Player A's hand and the 7 card from the table beside Player A as dead cards. However, Player A could also do the same with Player A's 3 card, picking up the table 3 card or in the further alternative, do the same with Player A's 2 card with the 2 card on the table. However, Player A could also chose to pick up the 7 and 5 card from the table with Player A's 2 card as 7−5=2. Player A could also pick up the 7, 3 and 2 cards from with Player A's 2 card as 7−3−2=2. This would give Player A four cards in Player A's dead card pile rather than only two cards from the three first described alternative plays and three cards in the fourth described alternative play. There are certain strategies as to which play the player will make at this time, depending on the number of players, how advanced in the game the play is and the number of dead cards the player has. In this example Player A picks up the 7, 3 and 2 cards and lays down the 2 card from Player A's hand which means 4 cards are placed in Player A's dead card pile, leaving the 5 card face up on the table and a 7 and a 3 card in Player A's hand.

Player B has a 9, a 6 and a 1 cards in Player B's hand with a 5 card on the table. Player B cannot pick up any cards and must lay a 9, a 6 or a 1 card on the table. There are certain strategies as to which card the player would lay down at this time, depending on the number of players, how advanced in the game the play is and the number of dead cards the player has. In this case Player B lays the 9 card on the table leaving Player B with a 6 and a 1 cards in Player B's hand and a 5 and a 9 cards on the table.

Player C has a 10, a 4 and a 2 cards in Player C's hand and there is a 5 and a 9 cards on the table. Player C can pick up the 9 and the 5 on the table with the 4 (9−5=4). This means that there are no table cards remaining, and Player C yells out “SCOOP!”. The game is over and Player C has won even though Player A has more dead cards and there are cards yet to be played if the SCOOP! had not happened.

In another example, the math card capture game may be played using addition and subtraction operators as the mathematical operators and may be referred to as the “both game”. The set up for the both game is similar to the set up for the addition math card capture game.

In the both game however, the player, on the player's turn, must:

i) choose a card from the table cards from which to first add and then subtract other table cards which will result in a number equal to a card in the player's hand; or

ii) place one of the player's hand cards face up on the table, which card then becomes a table card.

In the “both game” the addition or subtraction of zero is not allowed.

A play-by-play working example of the both game using both an addition operator and a subtraction operator is now described. The play-by-play working example is described for 4 players, Player A, Player B, Player C and Player D.

Dealt: a 7, a 3 and a 2 cards to Player A; a 9, a 6 and a 1 cards to Player B; a 10, a 4 and a 2 cards to Player C and a 7, a 10 and a 5 cards to Player D (the dealer) with a 7, a 5, a 3 and a 2 face up on the table.

Player A has a 7, a 3 and a 2 cards in Player A's hand and there are a 7, a 3, a 2 and a 5 cards face up on the table. Player A can win the game on the first turn. Player A can win with his 7 card by picking up all of the cards on the table—(7+3+2−5=7) or (7+5−2−3=7). Player A could also win with Player A's 3 card —(5+3+2−7=3).

In another example, the math card capture game may be played according to either the addition game, the subtraction game or the both game and may be referred to as the “either game”. The set up for the either game is similar to the set up for the addition math card capture game.

In the either game, on each of the player's turn, the player has the option to play the player's cards as if the player was playing either the addition game, the subtraction game or the both game.

A variation of this game could be that the players declare at the beginning of the game, the type of game the individual player is going to play on every turn throughout the game—either the addition game, the subtraction game or the both game. This can result in different rules for the pick-up of table cards for each player.

A further variation could be that for each player, instead of declaring, to use a die or a spin board at the beginning of the game to determine which game that player, on all of that player's turns, must play.

A further variation could be that on each player's turn, the player to the player's left declares the game rule for that player's turn. This game variation could lead to some interesting strategies depending on how many cards are on the table. The right strategy could make it impossible for the other player to pick-up or make it impossible to get a SCOOP! on that turn.

In another example, the math card capture game may be played according to a random selection of the addition game, the subtraction game or the both game and may be referred to as the “random game”. The set up for the random game is similar to the set up for the addition math card capture game.

In the random game a die is cast or a spin board is spun before each player's turn to determine what rules apply in order to pick-up or lay down card(s) on that player's turn.

For example, on each player's turn, the player may use a die or spin board to determine the game rule for that turn. A variation could be that on each player's turn, the player to the player's left could use a die or spin board to determine the game rule for that player's turn.

A further variation could be that a die is cast or a spin board is spun before each 3-card hand to determine what rules apply in order to pick-up or lay down card(s) for all players and all turns during that 3-card hand.

A further variation could be that a die is cast or a spin board is spun by each player before each 3-card hand to determine what rules apply to each player in order to pick-up or lay down card(s) for each player-s 3 turns during that 3-card hand.

In another example, the math card capture game may be played by capturing a table card and a hand card to generate a mathematical statement to yield a predetermined result of 22 and may be referred to as the “catch 22 game”. The set up for the catch 22 math card capture game is similar to the set up for the addition math card capture game.

In the catch 22 game, each player must use one or more cards on the table and a single card in the player's hand to create a mathematical equation or formula where the answer is 22. The players cannot use the number zero unless cards can create it in the formula.

The catch 22 game can be played without cards similar to the first variant of the math skill game—the math number capture game—described above. When the catch 22 game is played without cards, two or more numbers from a predetermined set of integer numbers are selected to create a mathematical equation or formula where the answer is 22. As stated above in regard to the math number capture game, the catch 22 game without cards can be formatted as a learning lesson in math books following a particular mathematical principle by requiring the student to select two of more numbers from a predetermined set of numbers and use the newly taught principle to generate an equation or formula with the selected numbers to yield a predetermined result, ie. the result of 22. This game can also be formatted as a math flash card game where two or more students compete to verbally state a correct formula once an instructor provides a card with a predetermined set of integer numbers. This game can also be played as a newspaper puzzle with differing degrees of difficulties.

A play-by-play working example of the catch 22 math card capture game is now described. The play-by-play working example is described for 2 players, Player A and Player B.

Dealt: a 7, a 3 and a 2 cards to Player A and a 9, a 6 and a 1 cards to Player B (the dealer) with a 7, a 5, a 3 and a 2 cards face up on the table.

Player A has a 7, a 3 and a 2 cards in Player A's hand and there are a 7, a 3, a 2 and a 5 cards face up on the table. Player A can win with the 2 card: 7+3+(2×5)+2=22.

Player A may also win with the 7 card: 5²−3+7−7=22.

Several illustrative variants and modifications of the math skill game have been described above for illustrative purposes, and are not intended as limitations. Still further variations, modifications and combinations thereof are contemplated some of which will now be described for further illustration. Still further variants, modifications or combinations thereof will be readily recognized by the person of skill in the art upon consideration of the embodiments described herein.

The math skill game may be implemented in various forms. The math skill game will typically comprise: a predetermined set of integer numbers, a predetermined integer result and instructions for selecting two or more of the integer numbers and generating a mathematical equation using the selected two or more integer numbers and at least one predetermined mathematical operator to yield the predetermined result. Typical method steps of the math skill game comprise: providing a predetermined set of integer numbers; providing a predetermined integer result; and selecting two or more integer numbers and generating a mathematical equation using the selected two or more of the integer numbers and at least one mathematical operator to yield the predetermined result. In an example of the math skill game, the predetermined set of integer numbers is displayed on a front surface of a flash card and possible corresponding mathematical equations are printed on a back surface of the flash card. In another example, the math skill game is presented as a query in a math book. The query may be a multiple choice query and the predetermined set of integer numbers may be displayed in a first portion of the query and at least one corresponding mathematical equation may be displayed as a choice in a second portion of the query. In a further example the math skill game is presented as a puzzle in a periodical publication and the puzzle may be presented in conjunction with a solution to a previous puzzle. The predetermined integer result may be fixed, such as a predetermined integer result of 22, or may be changing such as in the math card game where the predetermined integer result depends on choices presented by viewing available table cards at each player's turn.

The math card capture game has been described for two, three, four or six players. However, the math card capture game may be readily modified to accommodate other player numbers. For example, the math card capture game and/or the math number capture game may be played with one player, particularly in a computer-implemented version. Thus, the math card capture game and/or the math number capture game may be played with one or more players.

The math card capture game and/or the math number capture game is not limited to use of addition or subtraction operators only. Any combination of mathematical operators or functions may be used. For example, a math card capture game may comprise the use of both addition and subtraction operators at each turn or a player's choice as to use of only addition, only subtraction, or both addition and subtraction. In another example, multiplication and division operators may be used. In yet another example, addition, subtraction, multiplication and division operators may be used individually or in any combination as desired at each player's turn. In still another example, addition, subtraction, multiplication, division, root, exponent, logarithm, floating point (eg. floating decimal point), moving point (eg., moving decimal point, percentage), fraction, computer code, algorithm, and inverse operators may be used individually or in any combination as desired at each player's turn. Additionally, any positional numeral system may be used either alone or in combination, including for example binary (base 2), octal (base 8), decimal (base 10), duodecimal (base 12) or hexadecimal (base 16).

The math skill game, including the math number capture game and the math card capture game may accommodate any combination of mathematical operators or functions. In one example, the mathematical operator or function is any single arithmetic operator or any combination of arithmetic operators. In another example, a mathematical function is selected from the group consisting of logarithmic, root, exponential, trigonometric, inverse, and any combination thereof. In a further example, players can choose from predetermined combinations of mathematical operators and/or functions to capture one or more of a group of numbers provided to generate an equation that yields a predetermined result or a player selected result.

A use of a random generator device, such as a die or a spin wheel, to display a mathematical operator or function may be incorporated into the math card capture game. For example, a six sided die with a “+” displayed on two sides, “−” on two sides, and “+/−” could be used to set the choice of mathematical operator at the beginning of a game or at intervals within a game, such as at each deal or at each turn. In another example, a dice or spinner can be used at the beginning of the game to determine which game is going to be played or at intervals during the game, with the dice and spinner designations for addition, subtraction, either addition or subtraction or, both addition and subtraction. In further examples, a die or dice may accommodate any number or any combination of mathematical operators or functions. For example, the mathematical operator or function can be selected from the group consisting of addition, subtraction, division, multiplication, root, exponent, inverse, logarithmic function, and trigonometric function. Examples of mathematical operator displays on a six-sided die are shown in Table 1. In these examples, a side having a blank face provides a player with an opportunity to select any mathematical operation displayed on another face of that die. The number ‘1’ in Example 7 indicates multiplication or division by ‘1’. The number ‘0’ in Example 8 indicates addition or subtraction by ‘0’. Example 2 displays English language terms equivalent to mathematic symbols specified in Example 1. Similarly, Example 5 displays English language terms equivalent to mathematic symbols specified in Example 4.

TABLE 1
Illustrative samples of mathematical operators displayed
on a six-sided die.

| Exam- | 1st | 2nd | 3rd | 4th | 5th | 6th |
|---|---|---|---|---|---|---|
| ple # | Face | Face | Face | Face | Face | Face |
| 1 | + | − | | + | − | |
| 2 | plus | minus | | plus | minus | |
| 3 | + | − | + or − | + | − | + & − |
| 4 | + | − | × | ÷ | a^{b} | b√a |
| 5 | add | subtract | multiply | divide | exponent | root |
| 6 | + and × | + and − | + and ÷ | − and × | − and ÷ | × and ÷ |
| 7 | × | ÷ | 1 | × | ÷ | 1 |
| 8 | + | − | 0 | + | − | 0 |

The die may be of any conventional structure including 4, 6, 8, 10, or 12 sided die respectively providing 4, 6, 8, 10, or 12 die faces. The die will display a mathematical operator or function on a plurality of the die faces. Typically, the die may display a mathematical operator or function on a majority of the die faces such as at least 3 die faces of a 4 sided die, at least 4 die faces of a 6 sided die, at least 5 die faces of an 8 sided die, etc. In yet another example, two or more dice may be used with each die comprising a mathematical operator or function displayed on a majority of the sides/faces of the die. The two or more dice may display the same pattern of mathematical operators (for example, two dice, both displaying addition, subtraction, multiplication, and division) or different pattern of mathematical operators (for example, one die displaying addition and subtraction and another die displaying multiplication and division). An alternative random generator device may be one or more coins with mathematical operators displayed on each coin. For example, in a math skill game allowing use of only two different mathematical operators, the random generator may be a coin with a first mathematical operator displayed on a first face of the coin and a second mathematical operator displayed on a second face of the coin. In a still further example, the die/dice, the coin, or the spinner or a digital representation thereof may be incorporated into the math number capture game.

A timer device may be used in the math number capture game or the math card capture game. The timer device may be any conventional timer including, for example, a sand hourglass timer, a mechanical wind-up timer, a digital timer, a stop watch and the like. The timer device may be used to set a time limit for each player's turn.

A writing utensil and a writing sheet may be used in the math number capture game or the math card capture game. The writing utensil/sheet may be any conventional writing utensil/sheet including, for example, pen/paper, pencil/paper, eraseable marker/whiteboard, and the like.

In the math card capture game the deck of cards may be configured as desired depending on the application. The number of suits in a deck and the number of cards in a suit may vary depending on the specifics of an application. Typically the deck of cards will have at least two suits with each suit having at least 10 cards. In one example, the deck of cards will have four suits of ten cards. In another example, the cards may be designed to work in conjunction with the second language books of the region. The cards may have the numerical symbols of the numbers from 1 to 10 on the left side, beneath of which may be the numerical symbol of the number in roman numerals, Mandarin, Cantonese and/or Japanese. Across the top of the card may be the number spelled in the primary language of the region. Below the primary language spelled number, noun(s) may be depicted on the card. Some of the nouns may have a colour description—eg. “one red apple”, with the colour stated being printed in that colour. When the card is turned 180 degrees, the same configuration may be on the left side but the language will be in the second language with which the cards are made to be used in conjunction—eg. “une pomme rouge” in Canada , “una manzana roja” in the USA and “uma maçã vermelha” in South America. The cards may be designed in this manner in order for the players to learn numbers from 1 to 10 in 5 languages and 2 numerical symbols. The cards are also designed to introduce the players to nouns and/or colours in multiple languages, for example 40 different nouns in two languages as well as different colours, in two languages, in order to assist in second language vocabulary and reading skills.

The math skill game, including the math number capture game and/or the math card capture game, may include elements or indicia displayed in two or more languages. For example, the math skill game may display any word, for example a noun or a verb, in at least two different languages. In a more specific example, the math skill game may display a word for a colour in at least two different languages and/or a word for a numerical value in at least two different languages and/or a word for a mathematical operator in at least two different languages. In certain examples, the at least two different languages is a primary language and a secondary language for a geographical region. Examples of the at least two different languages include English/French, English/Spanish, English/Manadarin, English/Cantonese, English/Japanese, English/German, English/Russian, Mandarin/Cantonese or Spanish/Portugese.

The math card capture game may be played as a friendly version or a cutthroat version. In the “friendly game”, if a player makes a mistake and plays a card down on the table which could be used to pick-up cards, the other players are to tell the player and the player gets to pick up the cards as if the player had not made a mistake. Likewise, if a player attempts to pick up cards which do not add or subtract properly, the player is informed of the mistake and is given an opportunity to remedy the mistake by picking up the right cards or by playing another card in the player's hand.

In the “cutthroat game”, when a mistake occurs, the player is not given a chance to remedy the player's mistake. In the first instance described above, the first other player who catches a missed pick up can call SCOOP and gets the cards which could have been picked up as well as the card laid down on the table. In the second instance described above, the player must play the card which the player mistakenly used to attempt to pick up the table cards. This card must be laid on the table. In the event that the card can be used to pick up other cards on the table, the same rule as above applies and the first other player to call SCOOP gets the cards, otherwise the card becomes one of the table cards.

The math skill game has been described in detail with reference to hardcopy formats such as puzzles or queries printed in newspapers or books or card decks optionally including a random generator device such as die or dice for displaying mathematical operators or functions. It will be recognized that the math skill game can be represented in a digital format. Any of the elements or combination of elements of the math skill game may be represented in a digital format. More specifically, computer systems, computer implemented methods and/or computer readable medium embodying a computer program providing any variant or modification of the math skill game is contemplated. Computerized versions of the math skill game may be provided through any conventional platform, including a website available to players by communication through the Internet or a software application installed on an end-user computing device or any combination thereof.

In an example of a computer system for playing a math card capture game, the system comprises: a digital graphic representation of a deck of cards comprising at least two series of cards numbered consecutively from 1 to 10, each card bound by a face side and a back side, the face side displaying a numerical value; and a digital graphic representation of a random generator device displaying one or more mathematical operators; an end-user computing device comprising a display for viewing a plurality of table cards, a plurality of hand cards, and a random generator device, and an interface device for receiving player commands/actions for viewing one or more hand cards, actuating the random generator device at one or more intervals, and capturing cards by formulating an equation using at least one table card, at least one hand card and one or more available mathematical operators; the end-user computing device connected to a remote server computer over a network, the server computer configured for dealing a plurality of table cards face side up and dealing a plurality and equal number of hand cards face side down to each player, validating each player command for capturing cards, and counting captured cards for each player to determine a winner.

Examples of the random generator device include a slot machine, a roulette wheel, a die, a spin wheel, a coin and the like. Typically, a graphic representation of a die is a die comprising at least 4 sides and having a mathematical operator displayed on a plurality of the sides.

The computer system may accommodate any type of end-user computing device provided that the computing device can be networked to the system and is configured to display numbers and/or images, typically digital representations of puzzles or cards. For example, the computing device may be a desktop, laptop, notebook, tablet, personal digital assistant (PDA), PDA phone or smartphone, gaming console, portable media player, and the like. The end-user computing device is a player computing device that allows a player to input player commands/actions during each player's turn through the course of a math skill game, such as the math card capture game or the math number capture game. The computing device may be implemented using any appropriate combination of hardware and/or software configured for wired and/or wireless communication over the network. The computing device hardware components such as displays, storage systems, processors, interface devices, input/output ports, bus connections and the like may be configured to run one or more applications to allow, for example, a set of table cards to be displayed, a set of hand cards to be displayed, a random generator to randomly display one or more mathematical operators, a selection of a hand card, selection of one or more table card, an input box to enter an equation using the selected table cards and one or more mathematical operators to equal the selected hand card. The terms end-user computing device and client computing device may be used interchangeably when the system is implemented in a client/server arrangement.

The server computer may be any combination of hardware and software components used to store, process and/or provide images or numbers and actions associated with each image or number. The server computer components such as storage systems, processors, interface devices, input/output ports, bus connections, switches, routers, gateways and the like may be geographically centralized or distributed. The server computer may be a single server computer or any combination of multiple physical and/or virtual servers including for example, a web server, an image server, an application server, a bus server, an integration server, an overlay server, a meta actions server, and the like. The server computer components such as storage systems, processors, interface devices, input/output ports, bus connections, switches, routers, gateways and the like may be configured to run one or more applications to, for example, generate a card dealer function with a predetermined card deck, display digital representations of a set of table cards, display digital representations of a set of hand cards, display a digital representation of a random generator device such as dice to randomly display one or more mathematical operators, select of a hand card, select one or more table card, enter an equation using the selected table cards and one or more mathematical operators to equal the selected hand card.

The computer system may be implemented using a client/server implementation. The system may also accommodate a peer-to-peer implementation.

When a network is needed for player interaction, the network may be a single network or a combination of multiple networks. For example, the network may include the internet and/or one or more intranets, landline networks, wireless networks, and/or other appropriate types of communication networks. In another example, the network may comprise a wireless telecommunications network (e.g., cellular phone network) adapted to communicate with other communication networks, such as the Internet. Typically, the network will comprise a computer network that makes use of a TCP/IP protocol (including protocols based on TCP/IP protocol, such as HTTP, HTTPS or FTP).

The system may be adapted to follow any computer communication standard including Extensible Markup Language (XML), Hypertext Transfer Protocol (HTTP), Java Message Service (JMS), Simple Object Access Protocol (SOAP), Lightweight Directory Access Protocol (LDAP), and the like.

The system may accommodate any type of still or moving image file including JPEG, PNG, GIF, PDF, RAW, BMP, TIFF, MP3, WAV, WMV, MOV, MPEG, AVI, FLV, WebM, 3GPP, SVI and the like. Furthermore, a still or moving image file may be converted to any other file without hampering the ability of the system software to identify and process the image. Thus, the system may accommodate any image file type and may function independent of a conversion from one file type to any other file type.

Player actions and digital representations of puzzles or card games may be represented or facilitated by any convenient form or user interface element including, for example, a window, a tab, a text box, a button, a hyperlink, a drop down list, a list box, a check box, a radio button box, a cycle button, a datagrid or any combination thereof. Furthermore, the user interface elements may provide a graphic label such as any type of symbol or icon, a text label or any combination thereof. The user interface elements may be spatially anchored or centered around an associated image such that the user interface elements may appear at or near their corresponding image, for example an element listing choices for player action may be anchored to digital representation of the player's hand cards. Otherwise, any desired spatial pattern or timing pattern of appearance of user interface elements may be accommodated by the system.

The system described herein and each variant, modification or combination thereof may also be implemented as a method or code on a non-transitory computer readable medium (i.e. a substrate). The computer readable medium is a data storage device that can store data, which can thereafter, be read by a computer system. Examples of a computer readable medium include read-only memory, random-access memory, CD-ROMs, magnetic tape, optical data storage devices and the like. The computer readable medium may be geographically localized or may be distributed over a network coupled computer system so that the computer readable code is stored and executed in a distributed fashion.

Embodiments described herein are intended for illustrative purposes without any intended loss of generality. Still further variants, modifications and combinations thereof are contemplated and will be recognized by the person of skill in the art. Accordingly, the foregoing detailed description is not intended to limit scope, applicability, or configuration of claimed subject matter.

1. A math card capture game comprising:
a deck of cards comprising at least two series of cards numbered consecutively from 1 to 10, each card bound by a face side and a back side, the face side displaying a numerical value; and
a die comprising at least 4 sides and having a mathematical operator displayed on a plurality of the sides.

2. (canceled)

3. The math card capture game of claim 1, wherein the die comprises at least 8 sides and at least 5 sides display a mathematical operator.

4. The math card capture game of claim 1, wherein at least one mathematical operator is selected from the group consisting of addition, subtraction, division, multiplication, exponent, root, and any combination thereof.

5. (canceled)

6. The math card capture game of claim 1, wherein the deck of cards comprises at least 4 series of cards numbered consecutively from 1 to 10.

7. The math card capture game of claim 6, wherein each series of cards is numbered consecutively from 1 to 12.

8. The math card capture game of claim 1, wherein each series of cards is indicated by color and each card within the series displays a word for the color in at least two different languages.

9. The math card capture game of claim 1, wherein the face side displays a word for the numerical value in at least two different languages.

10. The math card capture game of claim 8, wherein the at least two different languages is a primary language and a secondary language for a geographical region.

11. (canceled)

12. The math card capture game of claim 1, further comprising instructions for dealing equal numbers of hand cards face down to two or more players, for dealing table cards face up, for rolling the die at one or more intervals and for capturing cards.

13. (canceled)

14. The math card capture game of claim 1, further comprising a timer.

15. The math card capture game of claim 1, further comprising a second die displaying a mathematical operator on a plurality sides.

16. The math card capture game of claim 1 implemented in a computing device.

17. A method of playing a math card capture game comprising:
providing a plurality of players, a math card capture game according to claim 1;
dealing a plurality of table cards face side up and dealing a plurality and equal number of hand cards face side down to each player;
rolling the die at one or more intervals to determine one or more available mathematical operators;
capturing cards during each player's turn by formulating an equation using at least one table card, at least one hand card and one or more available mathematical operators;
discarding a hand card to be placed face side up as a table card if the player is unable to formulate an equation during the player's turn; and
counting captured cards for each player to determine a winner.

18. The method of claim 17, further comprising declaring a player a winner of the game if the player captures all table cards in a single turn.

19. The method of claim 17, further comprising requiring discarding of a hand card if the player exceeds a predetermined allotted time during a turn without formulating a correct equation.

20. The method of claim 17, wherein the die is rolled prior to each turn.

21.-46. (canceled)

47. A math skill game comprising:
a predetermined set of integer numbers, a predetermined integer result and instructions for selecting two or more of the integer numbers and generating a mathematical equation using the selected two or more integer numbers and at least one predetermined mathematical operator to yield the predetermined result.

48. The math skill game of claim 47, wherein the predetermined set of integer numbers is displayed on a front surface of a flash card and possible corresponding mathematical equations are printed on a back surface of the flash card.

49. (canceled)

50. The math skill game of claim 47, wherein the instructions comprise a multiple choice query, wherein the predetermined set of integer numbers is displayed in a first portion of the query and at least one corresponding mathematical equation is displayed as a choice in a second portion of the query.

51.-53. (canceled)

54. A method of playing a math skill game comprising:
providing a predetermined set of integer numbers;
providing a predetermined integer result; and
selecting two or more integer numbers and generating a mathematical equation using the selected two or more of the integer numbers and at least one mathematical operator to yield the predetermined result.
